(19) United States
(12) Patent Application Publication
(10) Pub. No.: US 2011/0112263 A1
(43) Pub. Date: May 12, 2011

(54) ANIONIC POLYMERIZATION INITIATORS AND POLYMERS THEREFROM

(76) Inventors: Terrence E. Hogan, Akron, OH (US); William L. Hergenrother, Akron, OH (US); Yuan-Yong Yan, Copley, OH (US)

(21) Appl. No.: 13/010,290

(22) Filed: Jan. 20, 2011

Related U.S. Application Data
(63) Continuation of application No. 11/435,702, filed on May 17, 2006.
(60) Provisional application No. 60/683,152, filed on May 20, 2005.

(51) Int. Cl. C08F 4/48; C09K 3/00

(52) U.S. Cl. 526/183; 252/182.17

(57) ABSTRACT

One or more embodiments of the present invention provides a method for preparing a chain-extended lithiated thioacetal solution, the method comprising (i) preparing a lithiated thioacetal by reacting an initiator precursor compound with an organolithium compound; and (ii) chain extending the lithiated thioacetal by polymerizing monomer including conjugated diene monomer, optionally together with vinyl aromatic monomer, to form a polymeric or oligomeric segment having at least 3 and less than 125 repeat units.

This application is a Continuation Application of U.S. Non-Provisional application Ser. No. 11/435,702, filed on May 17, 2006, which claims the benefit of U.S. Provisional Application No. 60/683,152, filed May 20, 2005, which is incorporated herein by reference.

### FIELD OF THE INVENTION

One or more embodiments of this invention are directed toward chain-extended polymerization initiators and solutions of the same within a solvent that includes an aliphatic and/or cycloaliphatic solvent.

### BACKGROUND OF THE INVENTION

Anionic polymerization techniques have been used to synthesize polymers that are useful in the manufacture of tires. Certain initiators impart a functional group to the polymer, and these functional groups are believed to have a beneficial impact on the performance of tires.

The synthesis of polymers by anionic polymerization is often advantageously conducted in non-polar organic solvent. It is therefore desirable that the initiator compounds bearing the functional groups exhibit some useful degree of solubility in these solvents. In particular, it is highly desirable to employ aliphatic solvents such as technical hexanes, and therefore initiator compounds that exhibit useful solubility in these solvents are likewise highly advantageous.

Unfortunately, inasmuch functional initiators often include metallated organic ligands that include one or more hetero atoms, the solubility of these compounds in solvents, particularly aliphatic solvents, is limited. Moreover, the ability to predict which compounds are soluble in aliphatic solvents is extremely difficult inasmuch as the metallation of the organic species often alters the solubility characteristics.

Because functional initiators remain desirable, particularly for the synthesis for functionalized polymers that are used in the manufacture of tires, there is a continued desire to identify initiators that can lead to technologically useful polymers and that exhibit a technologically useful solubility in aliphatic solvents in order to facilitate the polymerization process.

### SUMMARY OF THE INVENTION

One or more embodiments of the present invention provides a method for preparing a chain-extended lithiated thioacetal solution, the method comprising (i) preparing a lithiated thioacetal by reacting an initiator precursor compound with an organolithium compound, where the initiator precursor compound is defined by the formula

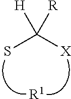

where R is selected from C₁ to C₆ trialkyl-silyl groups, C₁ to C₂₀ alkyl groups, C₄ to C₂₀ cycloalkyl groups, C₆ to C₂₀ aryl groups, thienyl, furyl, and pyridyl groups; and R may optionally have attached thereto any of following functional groups: C₁ to C₁₀ alkyl groups, C₆ to C₂₀ aryl groups, C₂ to C₁₀ alkenyl groups, C₃ to C₁₀ non-terminal alkynyl groups, ethers, tert-amines, oxazolines, thiazolines, phosphines, sulfides, silyls, and mixtures thereof; where R¹ is selected from the group consisting of C₂ to C₈ alkylene groups and where X is selected from the group consisting of S, 0 and NR, wherein R is as defined above, and may optionally have attached thereto any of the above identified functional groups to thereby produce a lithiated thioacetal having the general formula

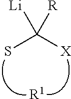

where R is selected from C₁ to C₆ trialkyl-silyl groups, C₁ to C₂₀ alkyl groups, C₄ to C₂₀ cycloalkyl groups, C₆ to C₂₀ aryl groups, thienyl, furyl, and pyridyl groups; and R may optionally have attached thereto any of following functional groups: C₁ to C₁₀ alkyl groups, C₆ to C₂₀ aryl groups, C₂ to C₁₀ alkenyl groups, C₃ to C₁₀ non-terminal alkynyl groups, ethers, tert-amines, oxazolines, thiazolines, phosphines, sulfides, silyls, and mixtures thereof; where R¹ is selected from the group consisting of C₂ to C₈ alkylene groups and where X is selected from the group consisting of S, 0 and NR, wherein R is as defined above, and may optionally have attached thereto any of the above identified functional groups; and (ii) chain extending the lithiated thioacetal by polymerizing monomer including conjugated diene monomer, optionally together with vinyl aromatic monomer, to form a polymeric or oligomeric segment having at least 3 and less than 125 repeat units.

Still other embodiments of the present invention provide an initiator solution comprising: (i) a chain extended thioacetal defined by the formula

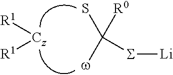

where Σ is a polymeric or oligomeric segment having at least 3 and less than 125 repeat units deriving from the polymerization of conjugated diene monomer and optionally vinyl aromatic monomer, each R¹ independently includes hydrogen or a monovalent organic group, R⁰ includes a monovalent organic group, z is an integer from 1 to about 8, and ω is sulfur, oxygen, or a tertiary amino group; and; (ii) a solvent comprising an aliphatic or cycloaliphatic solvent.

Other embodiments of this invention provide an initiator solution comprising (i) a chain extended thioacetal defined by the formula

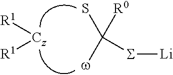

where Σ derives from the polymerization of conjugated diene monomer and optionally vinyl aromatic monomer to form a poly(dienyl) or poly(vinyl aromatic-co-dienyl) polymeric or oligomeric segment having at least 3 and less than 125 repeat units, each R¹ independently includes hydrogen or a monovalent organic group, R⁰ includes a monovalent organic group, z is an integer from 1 to about 8, and ω is sulfur, oxygen, or a tertiary amino group; and (ii) a solvent comprising an aliphatic or cycloaliphatic solvent.

### DETAILED DESCRIPTION OF ILLUSTRATIVE EMBODIMENTS

One or more embodiments of the invention include chain-extended initiator compounds that are useful for anionically polymerizing monomer including conjugated diene monomer. In one or more embodiments, these compounds may be characterized by an increased solubility in solvents that include aliphatic or cycloaliphatic solvents. This increased solubility in aliphatic or cycloaliphatic solvents is believed to result from a polymeric or oligomeric solubilizing component present within the compound. In one or more embodiments, the chain-extended initiator can advantageously be used to prepare polymers that are characterized by a technologically useful molecular weight distribution.

In one or more embodiments, the initiator compounds include lithiated thioacetals that include a polymeric or oligomeric solubilizing substituent. In general, lithiated aryl thioacetals are disclosed in International Application No. WO 2004/041870, and co-pending U.S. Ser. No. 60/683,231, which are incorporated herein by reference. For example, the initiator compounds may be prepared by reacting an initiator precursor compound with an organolithium compound, such as, n-butyllithium. These intitiator precursors have the formula:

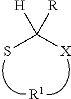

where R is selected from the group consisting of C₁ to C₆ trialkyl-silyl groups and functionalized groups thereof, C₁ to C₂₀ alkyl groups and functionalized groups thereof, C₄ to C₂₀ cycloalkyl groups and functionalized groups thereof, C₆ to C₂₀ aryl groups and functionalized groups thereof, thienyl, furyl, pyridyl and mixtures of the foregoing, where the functional groups are selected from the group consisting of C₁ to C₁₀ alkyl groups, C₆ to C₂₀ aryl groups, C₂ to C₁₀ alkenyl groups, C₃ to C₁₀ alkynyl groups, ethers, tert-amines, oxazolines, thiazolines, phosphines, sulfides, silyls, and mixtures thereof; where R¹ is selected from the group consisting of C₂ to C₈ alkylene groups and where X is selected from the group consisting of S, O and NR, wherein R is as defined above, and may optionally have attached thereto any of the above identified functional groups.

In one or more embodiments, the chain-extended thioacetal initiators of this invention can be defined by the formula

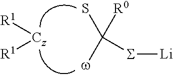

where Σ includes a polymeric or oligomeric segment, each R¹ independently includes hydrogen or a monovalent organic group, R⁰ includes a monovalent organic group, z is an integer from 1 to about 8, and ω includes sulfur, oxygen, or tertiary amino (NR, where R is an organic group). For example, chain-extended dithianes can be defined by the formula

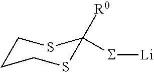

where Σ includes a polymeric or oligomeric segment, and R⁰ includes a monovalent organic group.

In one or more embodiments, the monovalent organic groups may include hydrocarbyl groups or substituted hydrocarbyl groups such as, but not limited to, alkyl, cycloalkyl, substituted cycloalkyl, alkenyl, cycloalkenyl, substituted cycloalkenyl, aryl, allyl, substituted aryl, aralkyl, alkaryl, and alkynyl groups, with each group preferably containing from 1 carbon atom, or the appropriate minimum number of carbon atoms to form the group, up to 20 carbon atoms. These hydrocarbyl groups may contain heteroatoms such as, but not limited to, nitrogen, boron, oxygen, silicon, sulfur, and phosphorus atoms.

In one or more embodiments, the polymeric or oligomeric segment may include at least 3 repeat units, and in other embodiments at least 5 repeat units, in other embodiments at least 10 repeat units, and in other embodiments at least 25 repeat units; in these or other embodiments, the polymeric or oligomeric segment may include less than 125 repeat units, in other embodiments less than 100 repeat units, in other embodiments less than 75 repeat units, and in other embodiments less than 50 repeat units.

In one or more embodiments, the repeat units of the polymeric or oligomeric segment may derive from polymerization of monomer including conjugated diene monomer. In these or other embodiments, the polymeric or oligomeric segment may also derive from monomer including vinyl aromatic monomer. In one or more embodiments, the polymeric or oligomeric segment is saturated. In other embodiments, the polymeric or oligomeric segment is unsaturated.

The conjugated diene hydrocarbons used in producing the initiators of this invention include unsaturated organic compounds that can be polymerized anionically in a reaction initiated by an alkali metal or its carbanionic derivative. These include conjugated dienes such as 1,3-butadiene, isoprene, 2,3-dimethyl-1,3-butadiene, 1,3-pentadiene (piperylene), 2-methyl-3-ethyl-1,3-butadiene, 3-methyl-1,3-pentadiene, 1,3-hexadiene, 1,3-octadiene, and myrcene.

Anionically polymerizable alkenyl-substituted aromatic compounds useful in practicing this invention include, but are not limited to, styrene, alpha-methylstyrene, vinyltoluene, 1-vinylnaphthalene, 2-vinylnaphthalene, 1-alpha-methylvinylnaphthalene, 2-alpha-methylvinylnaphathalene, 1,2-diphenyl-4-methylhexene-1 and mixtures of these, as well as alkyl, cycloalkyl, aryl, alkaryl and aralkyl derivatives thereof in which the total number of carbon atoms in the combined hydrocarbon constituents is generally not greater than 12. Examples of these latter compounds include 3-methylstyrene, 3,5-diethylstyrene, 2-ethyl-4-benzylstyrene, 4-phenylstyrene, 4-p-tolylstyrene, and 4,5-dimethyl-1-vinylnaphthalene. Again, reference is made to U.S. Pat. No. 3,377,404 for disclosures of additional vinyl-substituted aromatic compounds. Nonpolymerizable conjugated dienes and alkenyl substituted aromatic compounds such as 1,1-diphenylethylene and 2,4-hexadiene may also be used.

Examples of useful initiator compounds that may be chain-extended according to this invention include 2-lithio-2-methyl-1,3-dithiane, 2-lithio-2-phenyl-1,3-dithiane, 2-lithio-2-(4-dimethylamino) phenyl-1,3-dithiane, 2-lithio-2-trimethylsilyl-1,3-dithiane, and initiators selected from the group consisting of 2-lithio-2-phenyl-1,3-dithiane, 2-lithio-2-(4-dimethylaminophenyl)-1,3-dithiane, and 2-lithio-2-(4-dibutylaminophenyl)-1,3-dithiane, 2-lithio-[4-(4-methylpiperazino)]phenyl-1,3-dithiane, 2-lithio-[2-(4-methylpiperazino)]phenyl-1,3-dithiane, 2-lithio-[2-morpholino]phenyl-1,3-dithiane, 2-lithio-[4-morphulin-4-yl]phenyl-1,3-dithiane, 2-lithio-[2-morpholin-4-yl-pyridine-3]-1,3-dithiane, 2-lithio-[6-morphulin-4-pyridino-3]-1,3-dithiane, 2-lithio-[4-methyl-3,4-dihydro-2H-1,4-benzoxazine-7]-1,3-dithiane, and mixtures thereof.

Inasmuch as the chain extension segments of the initiator compounds of this invention can be low molecular weight polymers or oligomers, neat solutions or liquid mixtures of the initiator compounds can be prepared. In other words, solutions or mixtures that exclusively include or substantially include the chain-extended compounds of this invention, and which are in the liquid state, can be prepared.

In other embodiments, the initiator solutions of this invention include one or more of the initiator compounds defined above and a solvent that includes an aliphatic or cycloaliphatic solvent. These initiator solutions may be useful for preparing, storing, using, transporting, or delivering the initiator compounds of this invention. Some representative examples of suitable aliphatic solvents include n-pentane, n-hexane, n-heptane, n-octane, n-nonane, n-decane, isopentane, isohexanes, isoheptanes, isooctanes, 2,2-dimethylbutane, petroleum ether, kerosene, petroleum spirits, and mixtures thereof. Some representative examples of suitable cycloaliphatic solvents include cyclopentane, cyclohexane, methylcyclopentane, methylcyclohexane, and mixtures thereof. Mixtures of aliphatic and cycloaliphatic solvents may be employed.

In one or more embodiments, the solvent employed in the initiator solutions may also include an ether solvent. Useful ethers include tetrahydrofurane (THF), tetrahydropyran, diglyme, 1,2-dimethoxyethene, 1,6-dimethoxyhexane, 1,3-dioxane, 1,4-dioxane, anisole, ethoxybenzene, and mixtures thereof.

The mixtures of aliphatic or cycloaliphatic solvents and ether solvents may include up to about 65 volume percent aliphatic or cycloaliphatic solvent, in other embodiments up to about 55 volume percent aliphatic or cycloaliphatic solvents, or in other embodiments up to about 45% aliphatic or cycloaliphatic solvent, with the remainder including an ether; in these or other embodiments, the mixtures of aliphatic or cycloaliphatic solvents and ether solvents include at least 10 volume percent, in other embodiments at least 20 volume percent, in other embodiments at least 30 volume percent, and in other embodiments at least 40 volume percent aliphatic or cycloaliphatic solvent.

In one or more embodiments, solutions of chain-extended initiator compound and solvent can exclusively include aliphatic or cycloaliphatic solvents. It is believed that this can advantageously be achieved due to the increase in solubility of the chain-extended compounds over similar compounds that are not chain-extended.

The initiator compounds of this invention can be prepared by several synthetic routes. For example, WO 2004/041870, which in incorporated herein by reference, discloses methods for preparing dithiane compounds, as well as methods for lithiating dithiane compounds. In one or more embodiments, the thioacetals can be formed by reacting an aldehyde with 1,3-propanedithiol. These reactions may take place in the presence of a catalyst such as a Bronsted or Lewis acid.

Chain extension of the lithiated thioacetals can be carried out under a variety of conditions. In one or more embodiments, the reaction can be carried out in the temperature range of −30° C. to +60° C., or in other embodiments at 20° to about 50° C. The chain extension reaction may also be carried out in the presence of certain Lewis bases. The Lewis bases may be ethers, chosen from the group of aliphatic ethers such as diethyl ether, dimethyl ether, methyl tertiary butyl ether, tetrahydrofuran, and 2-methyltetrahydrofuran or tertiary amines chosen from the group of aliphatic amines such as trimethylamine, triethylamine, dimethylbutylamine, and N,N,N′,N′-tetramethylenediamine. The proportion of these Lewis bases to the lithiated thioacetal being chain-extended may vary. In one or more embodiments, from about 0.1 mole to 3.0 moles per mole of organolithium may be used.

In one or more embodiments, the chain-extended initiators can be prepared by first combining the thioacetal precursor with the monomer for chain extension, and subsequently adding to this mixture an organolithium compounds such as n-butyllithium. In other embodiments, the lithiated thioacetal can first be formed, and then the monomer for chain extension can be subsequently added to form the chain-extended initiator.

In one or more embodiments, the chain-extended initiators are prepared in solvents that include an ether. In other embodiments, the solvent may include a mixture of ether and an aliphatic or cycloaliphatic compound. These mixtures can be similar to those mixtures discussed above. After preparation of the chain-extended initiator, the ether can be removed by using conventional techniques. In one or more embodiments, the chain-extended initiator can be desolventized and/or dried, and subsequently dissolved in an aliphatic or cycloaliphatic solvent. In other words, an advantage of one or more embodiments of this invention is the ability to provide initiator solutions that are devoid or substantially devoid of ether even though an ether may be required to initially synthesize the compound. Therefore, according to one or more embodiments, the present invention includes solutions of chain-extended initiators where the solutions include a solvent that includes less than 10% by volume, in other embodiments less than 3% by volume, in other embodiments less than 1% by volume, in other embodiments less than 0.5% by volume, and in other embodiments less than 0.1% by volume of an ether solvent. In one or more embodiments, the initiator solutions are substantially devoid of ether solvents, where substantially devoid refers to that amount or less that would otherwise have an appreciable impact on the solution or its use, particularly an anionic synthesis.

The amount of olefinic monomer (e.g., conjugated diene) used to chain extend the lithiated thioacetal may vary from about one mole to about 125, in other embodiments from about 3 to about 120, and in other embodiments from about 5 to about 100 moles per mole of organolithium compound. In one or more embodiments, only a portion of the lithiated thioacetals may be chain-extended. In one or more embodiments, up to as much as 50 mole percent and in other embodiments up to 60 mole percent of the lithiated thioacetal may remain unextended and yet good solubility can be maintained.

In one or more embodiments, solutions of chain-extended lithiated thioacetals can be prepared. These solutions may advantageously be formed within aliphatic solvents. In one or more embodiments, the concentration of the chain extended lithiated thioacetals within the aliphatic solvents may be at least 0.2 molar, in other embodiments at least 0.5 molar, in other embodiments at least 0.8 molar, and in other embodiments at least 1.0 molar. These solutions may advantageously be stable as indicated by less than 1 mole percent, in other embodiments less than 0.5 mole percent, and in other embodiments 0.3 mole percent decay of the lithiated species over a 24 hour period at standard temperature and conditions. These solutions may be stored or transported in this concentrated, stable state and then subsequently added to a polymerization reactor to polymerize additional conjugated diene monomer.

The initiator compounds of this invention can be used to polymerize monomer including conjugated dienes according to conventional anionic polymerization techniques. In general, these processes include combining, introducing, or contacting the initiator compound with monomer. This combining or contacting may take place in the presence of a solvent. The process results in a living polymer that can be protonated or further functionalized.

Monomer that can be polymerized by the initiator compounds of the present invention include any monomer capable of being polymerized according to anionic polymerization techniques. These monomers include those that lead to the formation of elastomeric homopolymers or copolymers. Suitable monomers include, without limitation, conjugated C₄-C₁₂ dienes, C₈-C₁₈ monovinyl aromatic monomers, and C₆-C₂₀ trienes. Examples of conjugated diene monomers include, without limitation, 1,3-butadiene, isoprene, 1,3-pentadiene, 2,3-dimethyl-1,3-butadiene, and 1,3-hexadiene. A non-limiting example of trienes includes myrcene. Aromatic vinyl monomers include, without limitation, styrene, α-methyl styrene, p-methylstyrene, and vinylnaphthalene. When preparing elastomeric copolymers, such as those containing conjugated diene monomers and aromatic vinyl monomers, the conjugated diene monomers and aromatic vinyl monomers are normally used at a ratio of 95:5 to 50:50, and preferably 95:5 to 65:35.

The amount of initiator employed in conducting anionic polymerizations can vary widely based upon the desired polymer characteristics. In one or more embodiments, from about 0.1 to about 100, in other embodiments from about 0.33 to about 10, and in other embodiments from about 0.2 to 1.0 mmol of lithium per 100 g of monomer is employed.

The polymerization processes of this invention may be conducted in non-polar solvents and mixtures of non-polar solvents with polar-solvents including those discussed above. In order to promote randomization in copolymerization and to control vinyl content, a polar coordinator may be added to the polymerization ingredients. Amounts may range between 0 and 90 or more equivalents per equivalent of lithium. The amount may depend on the amount of vinyl desired, the level of styrene employed and the temperature of the polymerization, as well as the nature of the specific polar coordinator (modifier) employed. Suitable polymerization modifiers include ethers or amines to provide the desired microstructure and randomization of the comonomer units.

Compounds useful as polar coordinators include those having an oxygen or nitrogen heteroatom and a non-bonded pair of electrons. Examples include dialkyl ethers of mono and oligo alkylene glycols; “crown” ethers; tertiary amines such as tetramethylethylene diamine (TMEDA); linear THF oligomers; and the like. Specific examples of compounds useful as polar coordinators include tetrahydrofuran (THF), linear and cyclic oligomeric oxolanyl alkanes such as 2,2-bis(2′-tetrahydrofuryl) propane, di-piperidyl ethane, dipiperidyl methane, hexamethylphosphoramide, N-N′-dimethylpiperazine, diazabicyclooctane, dimethyl ether, diethyl ether, tributylamine and the like. The linear and cyclic oligomeric oxolanyl alkane modifiers are described in U.S. Pat. No. 4,429,091, incorporated herein by reference.

By reacting anionic initiators according to this reaction with certain unsaturated monomers, a living polymer is propagated into a polymeric structure. Throughout formation and propagation of the polymer, the polymeric structure may be anionic and “living.” A new batch of monomer subsequently added to the reaction can add to the living ends of the existing chains and increase the degree of polymerization. A living polymer, therefore, includes a polymeric segment having a living or reactive end. Anionic polymerization is further described in George Odian, Principles of Polymerization, ch. 5 (3^{rd} Ed. 1991), or Panek, 94 J. Am. Chem. Soc., 8768 (1972), which are incorporated herein by reference.

Anionically polymerized living polymers can be prepared by either batch or continuous methods. A batch polymerization is begun by charging a blend of monomer(s) and normal alkane solvent to a suitable reaction vessel, followed by the addition of the polar coordinator (if employed) and an initiator compound. The reactants may be heated to a temperature of from about 20 to about 130° C. and the polymerization may be allowed to proceed for from about 0.1 to about 24 hours. This reaction produces a reactive polymer having a reactive or living end. In one or more embodiments, at least about 30% of the polymer molecules contain a living end, in other embodiments at least about 50% of the polymer molecules contain a living end, and in other embodiments at least about 80% contain a living end.

The living polymer can be protonated or subsequently functionalized or coupled. Protonation can occur by the addition of any compound that can donate a proton to the living end. Examples include water, isopropyl alcohol, and methyl alcohol.

In other embodiments, the living polymer can be terminated with a compound that will impart a functional group to the terminus of the polymer. Useful functionalizing agents include those conventionally employed in the art. Types of compounds that have been used to end-functionalize living polymers include carbon dioxide, benzophenones, benzaldehydes, imidazolidones, pyrrolidinones, carbodiimides, ureas, isocyanates, and Schiff bases including those disclosed in U.S. Pat. Nos. 3,109,871, 3,135,716, 5,332,810, 5,109,907, 5,210,145, 5,227,431, 5,329,005, 5,935,893, which are incorporated herein by reference. Specific examples include trialkyltin halides such as triisobutyltin chloride, as disclosed in U.S. Pat. Nos. 4,519,431, 4,540,744, 4,603,722, 5,248,722, 5,349,024, 5,502,129, and 5,877,336, which are incorporated herein by reference. Other examples include cyclic amino compounds such as hexamethyleneimine alkyl chloride, as disclosed in U.S. Pat. Nos. 5,786,441, 5,916,976 and 5,552,473, which are incorporated herein by reference. Other examples include N-substituted aminoketones, N-substituted thioaminoketones, N-substituted aminoaldehydes, and N-substituted thioaminoaldehydes, including N-methyl-2-perrolidone or dimethylimidazolidinone (i.e., 1,3-dimethylethyleneurea) as disclosed in U.S. Pat. Nos. 4,677,165, 5,219,942, 5,902,856, 4,616,069, 4,929,679, 5,115,035, and 6,359,167, which are incorporated herein by reference. Additional examples include sulfur-containing or oxygen containing azaheterocycles such as disclosed in WO 2004/020475, U.S. Ser. No. 60/644,164 and U.S. Pat. No. 6,596,798, which are incorporated herein by reference. Other examples include boron-containing terminators such as disclosed in U.S. Ser. No. 60/591,065, which is incorporated herein by reference. Still other examples include cyclic siloxanes such as hexamethylcyclotrisiloxane, including those disclosed in copending U.S. Ser. No. 60/622,188, which is incorporated herein by reference. Further, other examples include α-halo-ω-amino alkanes, such as 1-(3-bromopropyl)-2,2,5,5-tetramethyl-1-aza-2,5-disilacyclopentane, including those disclosed in copending U.S. Ser. Nos. 60/624,347 and 60/643,653, which are incorporated herein by reference.

Useful coupling agents that can be employed in combination with the functionalizing agent include any of those coupling agents known in the art including, but not limited to, tin tetrachloride, tetraethyl ortho silicate, tetraethoxy tin, silicon tetrachloride, and mixtures thereof. In certain embodiments, the functionalizing agent can be employed in combination with other coupling or terminating agents. The combination of functionalizing agent with other terminating agent or coupling agent can be in any molar ratio.

In one embodiment, the functionalizing agent may be added to the living polymer cement (i.e., polymer and solvent) once a peak polymerization temperature, which is indicative of nearly complete monomer conversion, is observed. Because live ends may self-terminate, the functionalizing agent may be added within about 25 to 35 minutes of the peak polymerization temperature.

The amount of functionalizing agent employed to prepare the functionalized polymers is best described with respect to the equivalents of lithium or metal cation associated with the initiator. For example, the moles of functionalizing agent per mole of lithium may be about 0.3 to about 2, in other embodiments from about 0.6 to about 1.5, in other embodiments from about 0.7 to about 1.3, in other embodiments from about 0.8 to about 1.1, and in other embodiments from about 0.9 to about 1.0.

After formation of the polymer, a processing aid and other optional additives such as oil can be added to the polymer cement. The polymer and other optional ingredients may then be isolated from the solvent and optionally dried. Conventional procedures for desolventization and drying may be employed. In one embodiment, the polymer may be isolated from the solvent by steam desolventization or hot water coagulation of the solvent followed by filtration. Residual solvent may be removed by using conventional drying techniques such as oven drying or drum drying. Alternatively, the cement may be directly drum dried.

The functionalized polymers of this invention are particularly useful in preparing tire components. These tire components can be prepared by using the functionalized polymers of this invention alone or together with other rubbery polymers. Other rubbery elastomers that may be used include natural and synthetic elastomers. The synthetic elastomers typically derive from the polymerization of conjugated diene monomers. These conjugated diene monomers may be copolymerized with other monomers such as vinyl aromatic monomers. Other rubbery elastomers may derive from the polymerization of ethylene together with one or more α-olefins and optionally one or more diene monomers.

Useful rubbery elastomers include natural rubber, synthetic polyisoprene, polybutadiene, polyisobutylene-co-isoprene, neoprene, poly(ethylene-co-propylene), poly(styrene-co-butadiene), poly(styrene-co-isoprene), and poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched and star shaped. Other ingredients that are typically employed in rubber compounding may also be added.

The rubber compositions may include fillers such as inorganic and organic fillers. The organic fillers include carbon black and starch. The inorganic fillers may include silica, aluminum hydroxide, magnesium hydroxide, clays (hydrated aluminum silicates), and mixtures thereof.

A multitude of rubber curing agents may be employed, including sulfur or peroxide-based curing systems. Curing agents are described in 20 Kirk-Othmer, Encyclopedia of Chemical Technology, 365-468, (3^{rd} Ed. 1982), particularly Vulcanization Agents and Auxiliary Materials, 390-402, and A. Y. Coran, Vulcanization in Encyclopedia of Polymer Science and Engineering, (2^{nd} Ed. 1989), which are incorporated herein by reference. Vulcanizing agents may be used alone or in combination.

Other ingredients that may be employed include accelerators, oils, waxes, scorch inhibiting agents, processing aids, zinc oxide, tackifying resins, reinforcing resins, fatty acids such as stearic acid, peptizers, and one or more additional rubbers.

These stocks are useful for forming tire components such as treads, subtreads, black sidewalls, body ply skins, bead filler, and the like. Preferably, the functional polymers are employed in tread formulations. In one or more embodiments, these tread formulations may include from about 10 to about 100% by weight, in other embodiments from about 35 to about 90% by weight, and in other embodiments from about 50 to 80% by weight of the functional polymer based on the total weight of the rubber within the formulation. In one or more embodiments, the preparation of vulcanizable compositions and the construction and curing of the tire is not affected by the practice of this invention.

In one or more embodiments, the vulcanizable rubber composition may be prepared by forming an initial masterbatch that includes the rubber component and filler (the rubber component optionally including the functionalized polymer of this invention). This initial masterbatch may be mixed at a starting temperature of from about 25° C. to about 125° C. with a discharge temperature of about 135° C. to about 180° C. To prevent premature vulcanization (also known as scorch), this initial masterbatch may exclude vulcanizing agents. Once the initial masterbatch is processed, the vulcanizing agents may be introduced and blended into the initial masterbatch at low temperatures in a final mix stage, which preferably does not initiate the vulcanization process. Optionally, additional mixing stages, sometimes called remills, can be employed between the masterbatch mix stage and the final mix stage. Various ingredients including the functionalized polymer of this invention can be added during these remills. Rubber compounding techniques and the additives employed therein are generally known as disclosed in Stephens, The Compounding and Vulcanization of Rubber, in Rubber Technology (2^{nd} Ed. 1973).

The mixing conditions and procedures applicable to silica-filled tire formulations are also well known as described in U.S. Pat. Nos. 5,227,425, 5,719,207, 5,717,022, and European Patent No. 890,606, all of which are incorporated herein by reference. In one or more embodiments, where silica is employed as a filler (alone or in combination with other fillers), a coupling and/or shielding agent may be added to the rubber formulation during mixing. Useful coupling and shielding agents are disclosed in U.S. Pat. Nos. 3,842,111, 3,873,489, 3,978,103, 3,997,581, 4,002,594, 5,580,919, 5,583,245, 5,663,396, 5,674,932, 5,684,171, 5,684,172 5,696,197, 6,608,145, 6,667,362, 6,579,949, 6,590,017, 6,525,118, 6,342,552, and 6,683,135, which are incorporated herein by reference. In one embodiment, the initial masterbatch is prepared by including the functionalized polymer of this invention and silica in the substantial absence of coupling and shielding agents. It is believed that this procedure will enhance the opportunity that the functionalized polymer will react or interact with silica before competing with coupling or shielding agents, which can be added later curing remills.

Where the vulcanizable rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it may be heated to about 140 to about 180° C. Cured or crosslinked rubber compositions may be referred to as vulcanizates, which generally contain three-dimensional polymeric networks that are thermoset. The other ingredients, such as processing aides and fillers, may be evenly dispersed throughout the vulcanized network. Pneumatic tires can be made as discussed in U.S. Pat. Nos. 5,866,171, 5,876,527, 5,931,211, and 5,971,046, which are incorporated herein by reference.

Various modifications and alterations that do not depart from the scope and spirit of this invention will become apparent to those skilled in the art. This invention is not to be duly limited to the illustrative embodiments set forth herein.

What is claimed is:

1. A method for preparing a chain-extended lithiated thioacetal solution, the method comprising:
(i) preparing a lithiated thioacetal by reacting an initiator precursor compound with an organolithium compound, where the initiator precursor compound is defined by the formula 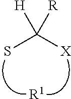
where R is selected from C₁ to C₆ trialkyl-silyl groups, C₁ to C₂₀ alkyl groups, C₄ to C₂₀ cycloalkyl groups, C₆ to C₂₀ aryl groups, thienyl, furyl, and pyridyl groups; and R may optionally have attached thereto any of following functional groups: C₁ to C₁₀ alkyl groups, C₆ to C₂₀ aryl groups, C₂ to C₁₀ alkenyl groups, C₃ to C₁₀ non-terminal alkynyl groups, ethers, tert-amines, oxazolines, thiazolines, phosphines, sulfides, silyls, and mixtures thereof; where R¹ is selected from the group consisting of C₂ to C₈ alkylene groups and where X is selected from the group consisting of S, 0 and NR, wherein R is as defined above, and may optionally have attached thereto any of the above identified functional groups to thereby produce a lithiated thioacetal having the general formula 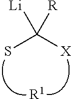
where R is selected from C₁ to C₆ trialkyl-silyl groups, C₁ to C₂₀ alkyl groups, C₄ to C₂₀ cycloalkyl groups, C₆ to C₂₀ aryl groups, thienyl, furyl, and pyridyl groups; and R may optionally have attached thereto any of following functional groups: C₁ to C₁₀ alkyl groups, C₆ to C₂₀ aryl groups, C₂ to C₁₀ alkenyl groups, C₃ to C₁₀ non-terminal alkynyl groups, ethers, tert-amines, oxazolines, thiazolines, phosphines, sulfides, silyls, and mixtures thereof; where R¹ is selected from the group consisting of C₂ to C₈ alkylene groups and where X is selected from the group consisting of S, 0 and NR, wherein R is as defined above, and may optionally have attached thereto any of the above identified functional groups; and
(ii) chain extending the lithiated thioacetal by polymerizing monomer including conjugated diene monomer, optionally together with vinyl aromatic monomer, to form a polymeric or oligomeric segment having at least 3 and less than 125 repeat units.

2. The method of claim 1, where the method takes place in an aliphatic solvent to form a solution.

3. The method of claim 2, where the solution includes at least 0.2 molar concentration of the lithiated thioacetal dissolved in the solvent at room temperature and standard conditions.

4. The method of claim 3, further comprising storing or transporting the solution.

5. The method of claim 4, further comprising adding the solution to a reactor and polymerizing additional conjugated diene monomer.

6. The method of claim 1, where said step of chain extending the lithiated thioacetal includes polymerizing monomer to include up to 125 repeat units of the monomer into the chain-extended species.

7. The method of claim 1, where said step of chain extending produces a chain extended thioacetal defined by the formula 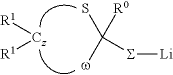
where Σ is a polymeric or oligomeric segment having at least 3 and less than 125 repeat units deriving from the polymerization of conjugated diene monomer and optionally vinyl aromatic monomer, each R¹ independently includes hydrogen or a monovalent organic group, R⁰ includes a monovalent organic group, z is an integer from 1 to about 8, and ω is sulfur, oxygen, or a tertiary amino group;
and a solvent comprising an aliphatic or cycloaliphatic solvent.

8. The method of claim 7, where Σ consists of a poly(dienyl) or poly(vinyl aromatic-co-dienyl) polymeric or oligomeric segment having at least 3 and less than 125 repeat units.

9. An initiator solution comprising:
(i) a chain extended thioacetal defined by the formula 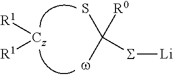
where Σ is a polymeric or oligomeric segment having at least 3 and less than 125 repeat units deriving from the polymerization of conjugated diene monomer and optionally vinyl aromatic monomer, each R¹ independently includes hydrogen or a monovalent organic group, R⁰ includes a monovalent organic group, z is an integer from 1 to about 8, and ω is sulfur, oxygen, or a tertiary amino group; and
(ii) a solvent comprising an aliphatic or cycloaliphatic solvent.

10. The initiator solution of claim 9, where the solvent includes at least 80 volume percent aliphatic or cycloaliphatic solvent.

11. The initiator solution of claim 10, where the solvent includes at least 90 volume percent aliphatic or cycloaliphatic solvent.

12. The initiator solution of claim 11, where the solvent includes at least 95 volume percent aliphatic or cycloaliphatic solvent.

13. The initiator solution of claim 12, where the solvent includes at least 99 volume percent aliphatic or cycloaliphatic solvent.

14. The initiator solution of claim 9, where the chain extended thioacetal includes a chain extended thioacetal selected from the group of thioacetals consisting of 2-lithio-2-methyl-1,3-dithiane, 2-lithio-2-phenyl-1,3-dithiane, 2-lithio-2-(4-dimethylamino)phenyl-1,3-dithiane, 2-lithio-2-trimethylsilyl-1,3-dithiane, and initiators selected from the group consisting of 2-lithio-2-phenyl-1,3-dithiane, 2-lithio-2-(4-dimethylaminophenyl)-1,3-dithiane, and 2-lithio-2-(4-dibutylaminophenyl)-1,3-dithiane, 2-lithio-[4-(4-methylpiperazino)]phenyl-1,3-dithiane, 2-lithio-[2-(4-methylpiperazino)]phenyl-1,3-dithiane, 2-lithio-[2-morpholino]phenyl-1,3-dithiane, 2-lithio-[4-morphulin-4-yl]phenyl-1,3-dithiane, 2-lithio-[2-morpholin-4-yl-pyridine-3]-1,3-dithiane, 2-lithio-[6-morphulin-4-pyridino-3]-1,3-dithiane, 2-lithio-[4-methyl-3,4-dihydro-2H-1,4-benzoxazine-7]-1,3-dithiane, and mixtures thereof.

15. The initiator solution of claim 9, where the polymeric or oligomeric segment includes at least 3 repeat units.

16. The initiator solution of claim 9, where the polymeric or oligomeric segment includes at least 5 repeat units and less than 125 repeat units.

17. The initiator solution of claim 9, where the solvent includes less than 10% by weight ether solvent.

18. The initiator solution of claim 9, where the solvent is substantially devoid of an ether solvent.

19. An initiator solution comprising:
(i) a chain extended thioacetal defined by the formula 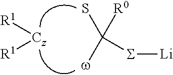
where Σ derives from the polymerization of conjugated diene monomer and optionally vinyl aromatic monomer to form a poly(dienyl) or poly(vinyl aromatic-co-dienyl) polymeric or oligomeric segment having at least 3 and less than 125 repeat units, each R¹ independently includes hydrogen or a monovalent organic group, R⁰ includes a monovalent organic group, z is an integer from 1 to about 8, and ω is sulfur, oxygen, or a tertiary amino group; and
(ii) a solvent comprising an aliphatic or cycloaliphatic solvent.
